(19) United States
(12) Patent Application Publication
(10) Pub. No.: US 2001/0001631 A1
(43) Pub. Date: May 24, 2001

(54) Writing instrument

(76) Inventors: Andrew J. Platts, Chesterfield, MO (US); Mark G. Collins, St. Ann, MO (US)

Correspondence Address: JOHN W KELPER, III, 7733 FORSYTH BLVD., 12TH FLOOR, ST LOUIS, MO, 63105

(21) Appl. No.: 09/760,549

(22) Filed: Jan. 16, 2001

Related U.S. Application Data
(63) Continuation of application No. 09/219,966, filed on Dec. 23, 1998.

(51) Int. Cl. A45D 40/20; B43K 29/00

(52) U.S. Cl. 401/88; 401/195

(57) ABSTRACT

A writing instrument having rotatable beads of various shapes and sizes abutting one another so that the beads form logos, designs, words or messages for promotional or advertising purposes. The beads provide an ergonomically pleasing sensation to the user and further provide an element of amusement to the user.

### BACKGROUND OF THE INVENTION

1. Field of the Invention

This invention relates to the field of writing instruments, and more particularly, relates to a writing instrument having beads positioned about the writing instrument for amusement purposes or as an advertising and promotional device.

2. Related Art

Writing instruments, such as pens, are an everyday part of our lives. They remain the most common implements for effecting non-verbal communication. Additionally, writing instruments, such as ball point pens, are frequently utilized in advertising and promotion for businesses. It is believed that several million ballpoint pens are sold each year in the United States alone as promotional give-away items for vendors of various goods and services. Fundraisers of all types, including fundraisers for various educational and religious entities, also utilize the sale of writing utensils to procure funding for various projects. There exists a need to provide a writing instrument, such as a pen or pencil, with a novel means of providing advertising and to promote businesses, groups, ideas, beliefs and displays fanciful messages.

It is well known to provide a writing instrument, such as a pen or pencil, with sleeves or cylindrical members for keeping a calendar. For instance, U.S. Pat. No. 2,445,170 to Gonczi provides a writing instrument having a built-in calendar in a cap, consisting of multiple cylinders on a single axis. The device disclosed by Gonczi records information on interfitting cylinder members and disclosed the information by way of day, month and year (as recorded on separate cylinders) through windows on the outer most cylinder members. However, the Gonczi fountain pen is not adapted to display advertisements or otherwise allow the seller to promote its goods or services or to provide amusement to the user. Moreover, the device disclosed does not allow the seller to provide the writing instrument with various shapes and sizes to aid in promoting the seller's business.

Similarly, U.S. Pat. No. 2,577,259 to Millington and U.S. Pat. No. 2,702,439 to Swenssen disclose devices having calendars on their exterior surfaces and being adapted to hold writing instruments. Like Gonczi, the Millington and Swenssen devices provide cylindrical members, one on top of the other in an interfitting manner, that work in unison to display the day, month and year when the user manipulates the cylinder members into the appropriate positions. As such, these devices are not adapted for, nor do they suggest, advertising or promotion uses. Moreover, both Millington and Swenssen relate to holders of writing utensils where the disclosed devices are fitted over the writing utensil, thus adding additional cost and complexity to the writing instrument itself.

There have been a number of penholder designs employed for the purpose of amusement. For example, U.S. Pat. No. 4,983,062 to Hour relates to a penholder with puzzle blocks whereby a number of blocks with slideable lateral faces are received about a stem that encompasses an ink cartridge. The blocks are arranged such that the user moves the slideable faces between the various rotatable blocks as a puzzle game similar to a RUBICS CUBE®. However, the device disclosed in Hour is relatively complex and costly to manufacture and is not well adapted for use as an advertising or promotional device. Moreover, the Hour device is a penholder, not a writing instrument, again adding to the cost of manufacture by necessitating additional components and assembly expense.

The patent which issued to Lude (U.S. Pat. No. 2,357,940) shows a device for counting words and symbols of messages, such as a telegraph message, consisting of a counting mechanism stored in the casing of a writing instrument. The counting mechanism is actuated by depressing the point of the device (i.e., a pen or pencil) adjacent to each word or symbol to be counted and displays the number of words or symbols thus counted through windows on the casing of the device. The Lude device is not, however, intended as an item for advertising and promotion or for amusement of the user. Additionally, the counting mechanism disclosed requires a great deal of space, thus making the device rather unwieldy and uncomfortable to the user.

Accordingly, there exists a need to provide a writing instrument that is adapted for advertising, promotion and amusement, esthetically pleasing, simple and inexpensive to manufacture and ergonomically pleasing to the user.

### SUMMARY OF THE INVENTION

In order to overcome the shortcomings of known writing instruments, the present invention has been developed with a number of goals in mind, principal of which is to provide a new and improved writing utensil holder which is rugged and simple in construction, pleasing in appearance and in operation, inexpensive to manufacture and can be used to advertise and promote the goods and services of a vendor and provide amusement to its user.

The present invention provides a writing instrument, which comprises a writing member, a nib or writing end, a plurality of rotatable indicia, and an end or cap socket. The indicia, nominally beads, are adapted to rotate about the writing member. Each of the rotatable indicia may be selected from the geometric group consisting of spheres, cylinders, cubes, polyhedrons and other shapes, each having a bore through its center line axis for being received about the center line axis of the writing member. The indicia are nominally decorated on their exterior surface with symbols, lettering or numbering, such that, when arranged together about the writing member, the indicia form a logo, spell words, form symbolic messages or present a purely fanciful display. The decorations on each exterior surface of the indicia may be of a different color, or display a different letter, number or symbol to add to the amusement value of the writing instrument. The indicia also provide a gripping surface for the writing instrument that is ergonomically pleasing to the user.

The present invention serves the purpose of being a low cost writing instrument which, at the same time, provides advertising, promotion, and identification to the seller and amusement to the user.

Other objects or advantages will be apparent or pointed out in the following description.

### BRIEF DESCRIPTION OF THE DRAWINGS

For a better understanding of the present invention, reference should be had to the following detailed description taken in conjunction with the drawings in which:

FIG. 1 is a perspective view showing a new and improved writing instrument with indicia according to the invention.

FIG. 2 is an exploded perspective view of the writing instrument with beads shown in FIG. 1;

FIG. 3 is an exploded perspective view of a second embodiment of the writing instrument of this invention;

FIG. 4 is a perspective view of a further embodiment of the present invention, utilized as a pencil;

Corresponding reference characters identify corresponding elements throughout the several views of the drawings.

### DETAILED DESCRIPTION OF PREFERRED EMBODIMENTS

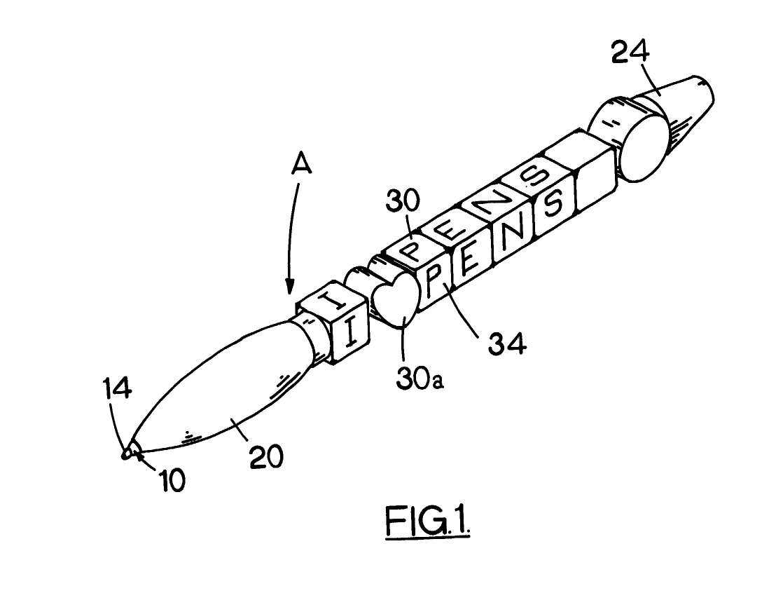

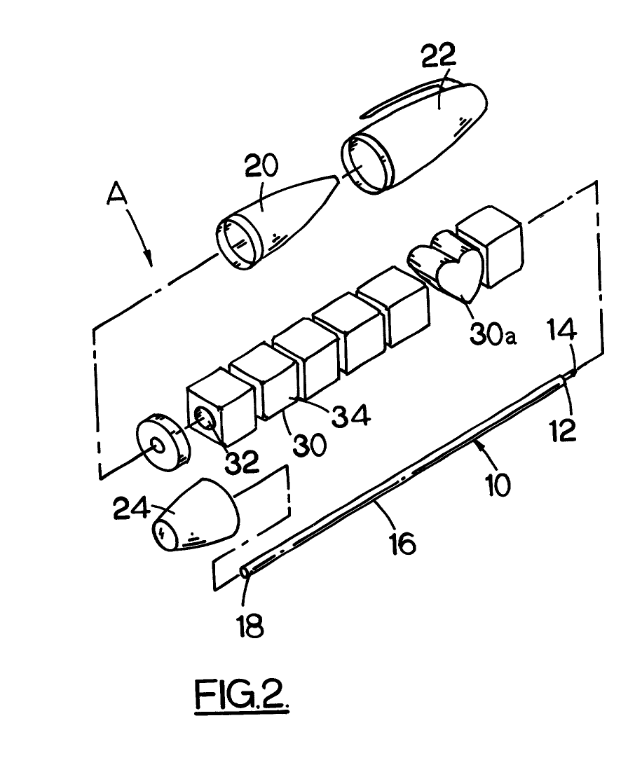

Referring to FIGS. 1-2 of the drawings, a first embodiment of a writing instrument of the invention is designated A, and includes a writing member 10, a nib or front socket 20, a cap or end socket 22, an aft socket 24 and a plurality of rotatable indicia 30.

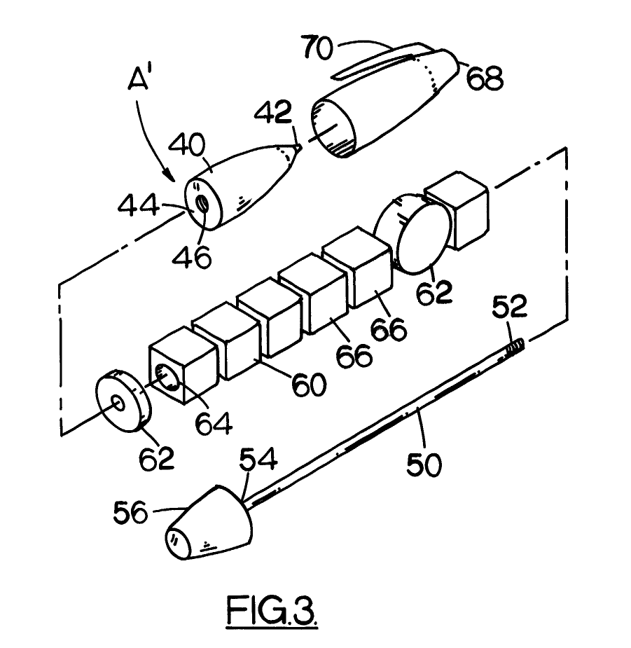

The writing member 10 provides the invention with a means of writing, and can be an ink cartridge, a pencil, a crayon or other writing implement such as a fluorescent marker or the like. In embodiment A of the present invention, writing member 10 is a well-known ballpoint pen having a cylindrical tubular ink reservoir. FIG. 3 shows a second embodiment where the writing member 10 is a pencil.

Indicia 30 are, in essence, bead members of various geometric shapes including spheres, cubes, cylindrical discs, and fanciful shapes including hearts, and well-known shapes of objects such as footballs, basketballs, golfballs and the like. The indicia are preferably made of plastic; however, it will be readily apparent that many other substances with long-wearing properties, such as wood, metal, closed cell foam, ceramics, etc., can be readily substituted. Each of the rotatable indicia 30 is provided with an identical axial through-hole or bore 32 for assembling on the writing member 10 between said nib socket 20 and said aft socket 24, as is more fully discussed below.

As shown in FIG. 1, those indicia 30 shaped as cube have four exterior surfaces, designated 34. It is conceivable that the exterior surfaces 34 of a number of indicia 30 will be provided with letters of the alphabet or numbers arranged to spell a message, theme, or name. It is also envisioned that the exterior surfaces of indicia 30 will have pictorial representations of various animate and inanimate objects, symbols and logos. Similarly, the indicia can be arranged to display a symbolic message. Those indicia of spherical or ovular shape may have disposed about their surface circumference a variety of letters, numbers, symbols, logos, etc.

Nib socket 20 is fitted about the head 12 of writing member 10 and provides an initial gripping surface for the writing instrument A. As shown in FIG. 2, end socket 22 is fitted about the nib socket 20 to cover the nib or writing end 14 of writing member 10. A plurality of the rotatable indicia 30 are then fitted about the ink cartridge 16 of writing member 10 in a number so as to sufficiently cover the ink cartridge 16. Aft socket 24 is then fitted to cap end 18 of writing member 10 so as to fully enclose ink cartridge 16 to prevent accidental blotting or spilling of the ink contained therein.

Indicia 30 can be provided of various sizes depending upon the words, symbol, logo or message to be conveyed. Similarly, a variety indicia 30 with blank exterior surface can be used to act as spacing between multiple words or character symbols. As noted above, certain indicia 30a can be fashioned as fanciful shapes, such as hearts, to act as words, namely “love,” as shown in FIG. 1. Indicia 30 can also take the form of other well-known shapes, such as footballs, baseballs and golf balls to emphasize a product of the vendor or a theme.

Indicia 30, when arranged about writing member 10, act to form a gripping surface for the writing instrument A. The shape and size of indicia 30, and their ability to rotate about the writing member 10, provide comfort and an ergonomically pleasing effect to the user. The rotatability of indicia 30 about writing member 10 also provides amusement to the user.

FIG. 3 shows a variation of the writing instrument previously herein described. As shown in this figure, writing instrument A′ includes an ink cartridge 40 having a nib or writing end 42 and a flat base section 44. Base section 44 can be provided with a threaded vertical bore 46 which is adapted to threadably engage a threaded rod section 50 as is hereinafter more fully described.

Writing instrument A′ also includes a rod section 50 and a plurality of rotatable shaped indicia 60 and 62. Rod section 50 further includes a first smooth threaded end 52, and a second socket end 54 and an end cap 56. Rotatable indicia 60 and 62 are each provided with a bore 64. Exterior surfaces of indicia 60 and 62 are provided with letters, numbers, or designs as hereinabove described. The indicia are also of similar shapes and formed of materials as hereinbefore more fully described. Adapted for placement over cartridge nib end 42 is cap 68 which may further be provided with a pocket clip member 70.

Writing instrument A′ is assembled by first placing a sufficient number of rotatable indicia 60 and 62 in an arranged design so as to form an appropriate display onto rod section 50 and then threadably engaging threaded end 52 and cartridge threaded bore 46 by inserting rod section 50 into cartridge base 44.

There are many variations in the construction of writing instrument A′. For example, ink cartridge 40 can be adapted to accept ball pen or fountain pen ink and writing end 42 can be a ballpoint or fountain pen nib. Base section bore 46 can be threaded for threadable engagement or smooth for glue or a friction fit insertion of the rod section 50. Similarly, rod section 50 can be plastic, wood or metal.

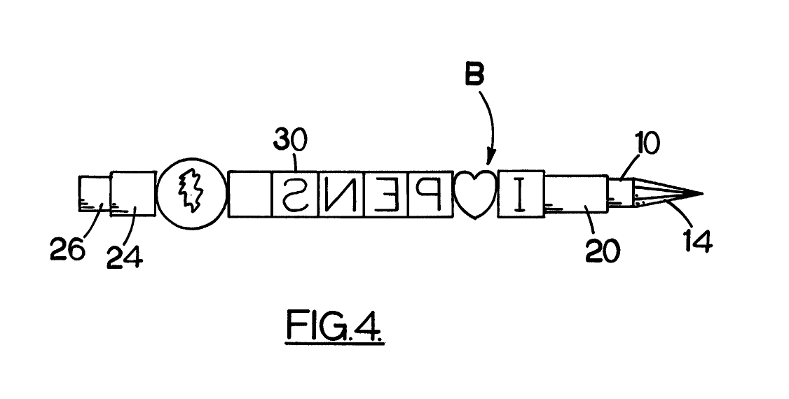

FIG. 4 shows an alternative embodiment of the present invention, designated as B, where the writing member 10 is a pencil. Nib socket 20 is fitted over writing member 10 near its writing end 14. Indicia 30 are then threaded onto writing instrument 10 from cap end 18 in sufficient number to spell or depict the desired message. Aft socket 24 is then fitted over cap end 18 (not shown) of writing instrument 10 to retain indicia 30 about writing instrument 10 and, alternatively, to retain an eraser 26.

In view of the foregoing description of the present invention and various embodiments and methods, it will be seen that the several objects of the invention are achieved and other advantages are attained.

The embodiment which has been described in order to best explain the principles of the invention and its practical application to thereby enable others skilled in the arts to best utilize the invention in various embodiments and with various modifications as are suited to the particular use contemplated.

As various modifications could be made in the construction and methods herein described and illustrated without departing from the scope of the invention, it is intended that all matter contained in the foregoing description or shown in the accompanying drawings shall be interpreted as illustrative rather limiting.

What is claimed is:

1. A writing instrument comprising:
means for writing having a nib end and a socket end, and
a plurality of indicia, wherein each indicia is provided with a central bore for placement on said writing means between said nib end and said socket end.

2. The writing instrument of claim 1, wherein said writing means is a cylindrical ink cartridge.

3. The writing instrument of claim 1, wherein said writing means is a pencil.

4. The writing instrument of claim 1, wherein some or all of said indicia are beads.

5. The writing instrument of claim 4, wherein the shape of said beads is selected from the geometric group consisting of spheres, cubes and polyhedrons.

6. The writing instrument of claim 5, wherein the outer surface of said beads is decorated with caricatures, symbols, lettering or numbering.

7. The writing instrument of claim 1, wherein said indicia are rotatable and can freely rotate about said writing means.

8. A pen comprising:
an ink cartridge having a writing end and a cap end,
a plurality of beads, each having a central bore positioned on said cartridge between said writing end and said cap end, and
a message consisting of symbols, letters or numbers affixed to the exterior surface of said beads.

9. A writing instrument comprising:
an ink filled cartridge having a nib end and a flat base section, wherein said base section contains a vertical bore;
a rod section having a first smooth end and a second socket end wherein said first end is adapted for insertion into said cartridge bore; and
a plurality of indicia placed on said rod section prior to insertion of said rod section into said cartridge bore.

10. The writing instrument of claim 9 further comprising:
a base section having a threaded vertical bore; and
a rod section having a threaded first end for threadable engagement in said bore.

11. The writing instrument of claim 9 further comprising:
an end cap for placement over said cartridge nib end.

12. The writing instrument of claim 11, wherein said end cap contains a pocket clip member.
